(19) United States
(12) Patent Application Publication
(10) Pub. No.: US 2011/0259930 A1
(43) Pub. Date: Oct. 27, 2011

(54) ROOF MODULE

(76) Inventor: Conrad Rossel, Syrgenstein (DE)

(21) Appl. No.: 12/998,524

(22) PCT Filed: Jun. 16, 2010
(86) PCT No.: PCT/EP2010/003603

§ 371 Date: Jul. 12, 2011

(30) Foreign Application Priority Data
Jul. 31, 2009 (DE) 10 2009 035 860.9

(51) Int. Cl. B60R 9/04

(52) U.S. Cl. 224/309

(57) ABSTRACT

A roof module is used for mounting on a roof of a vehicle. It comprises a self-supporting support frame on which components are mounted. The support frame is arranged independently of the vehicle roof. The components comprise at least electric energy storage modules. A shielding plate is arranged on the support frame between the electric energy storage modules and the vehicle roof.

The invention relates to a roof module for mounting on a vehicle roof, the module being of the type defined in closer detail in the preamble of claim 1.

It is principally known from the state of the art to arrange functional components in the roof area of vehicles, and especially commercial vehicles or buses. Reference is hereby made by way of example to DE 10 2005 028 853 A1 which shows a roof for a commercial vehicle, especially an omnibus, with a functional unit being integrated in the roof which may comprise electrical components of a fuel cell system or devices for firefighting.

A roof module for a vehicle with integrated air-conditioning system is known from DE 103 50 177 A1. It is provided in addition to the air-conditioning system that a fuel cell system is also arranged in the roof module. The described roof module can be arranged as a fully pre-mounted vehicle roof with adjacent modules. It especially comprises a supporting roof structure which can be placed on the vehicle in its entirety during final assembly.

This strongly limits the flexibility for use in various vehicles because there is a respective limitation to the respectively matching vehicle as a result of the roof structure of the roof module which is pre-mounted as an entire unit. If it is intended to equip different vehicles with roof modules, different roof modules are necessary for the individual types of vehicles, which thus make the roof modules expensive and complex.

It is a further disadvantage of roof modules which comprise electrical components that passengers of a vehicle, especially in a passenger car or an omnibus, will sit relatively close to the electronic components of the roof module because they are arranged directly above the passengers. Persons can thus be subjected to electromagnetic radiation and electronic components attached to the vehicle can be disturbed as a result of the electronic and/or electric components installed in the roof module.

It is therefore the object of the present invention to provide a functional roof module which offers optimal configuration concerning its stability and electromagnetic compatibility (EMC).

The object is achieved in accordance with the invention by a roof module with the features in the characterizing part of claim 1. Advantageous embodiments and further developments of the roof module are provided in the dependent sub-claims.

The components in the roof module in accordance with the invention comprise electrical power storage modules in any case. A shielding plate is arranged on the support frame in accordance with the invention between these electrical power storage modules and the vehicle roof. This shielding plate, which is not arranged in a supporting manner itself, can preferably be arranged as a zinc-plated sheet-metal part. It shields the components on the support frame of the roof module against the vehicle roof and thus against persons and electronic components in the vehicle. This leads to a very simple and compact configuration which is non-critical with respect to the electromagnetic compatibility in interaction with the vehicle and with the electronic components arranged in the vehicle and/or the travelling passengers. As a result of the support frame which carries the roof module in a supporting manner, a configuration is further achieved which offers high flexibility in mounting the roof module on different vehicles. In particular, the roof module can be arranged in such a way that it has standardized distances of connecting elements, so that it can be adapted accordingly to various vehicles for example, especially various omnibuses of a manufacturer, when they comprise fastening elements in the roof region at a comparable distance. The support frame can also lead to a certain flexibility in the shape of the vehicle roof because it can be arranged by means of respective longitudinal and transverse struts in such a way that a certain distance to the roof remains ensured, so that different curvatures of the vehicle roof are possible underneath the roof module that is mounted on the same.

The shielding plate, which is connected with the ground of the electronic components in the roof module as is common practice in shielding plates, ensures shielding in every case, irrespective of the material and arrangement of the vehicle roof arranged under the roof module.

It is further provided in a very favorable and advantageous embodiment of the roof module in accordance with the invention that it comprises an electric storage unit for a hybrid drive of the vehicle. This arrangement of the roof module as an electric storage unit for a vehicle also comprises the respective components of the power electronics and a power converter in addition to the already mentioned electric storage modules which can be arranged for example in form of batteries or supercaps. This leads to a substantially autonomously working electric storage unit as can be used for example in hybrid drives, especially diesel/electric hybrids in commercial vehicles, especially omnibuses. Preferably, the entire roof module will merely be this electric storage unit.

It is further provided in a further very advantageous embodiment of the roof module in accordance with the invention that electric line elements to and from the components are arranged closely next to one another. These line elements which lie closely next to one another and which conduct current in the one and also in the other direction thus emit no or only very minimal radiation.

Further advantageous embodiments of the roof module in accordance with the invention are provided in the remaining dependent sub-claims and will become clear by reference to the embodiment which will be explained below in closer detail by reference to the drawings, wherein:

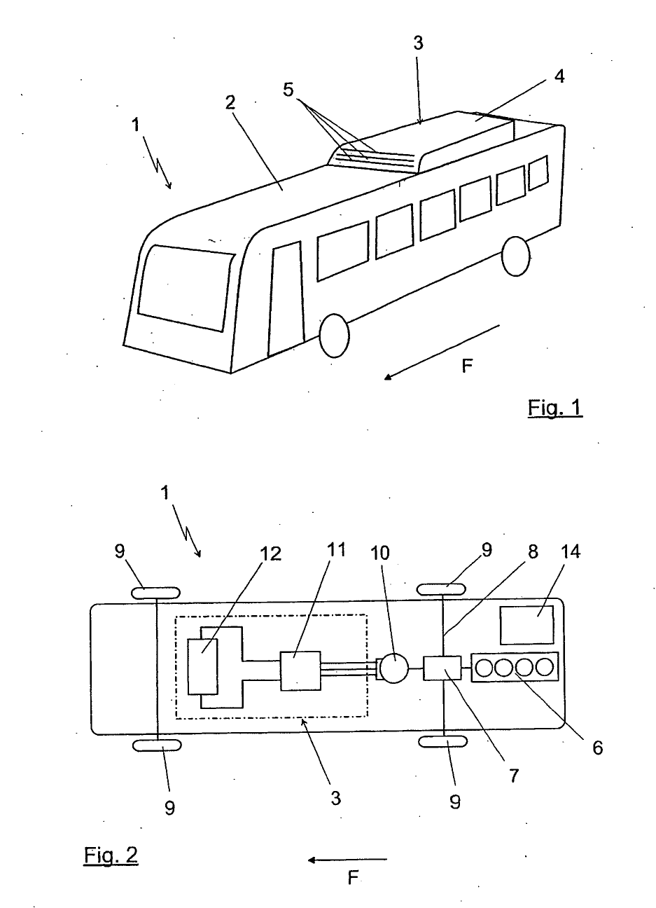

FIG. 1 shows a schematic view of an omnibus as a vehicle;

FIG. 2 shows a schematic view of a the hybrid drive of omnibus 1;

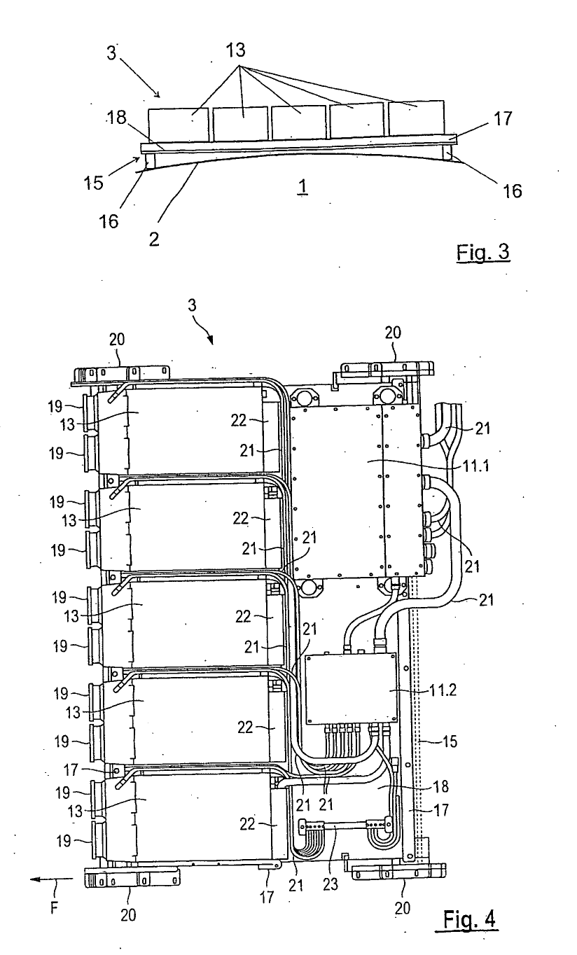

FIG. 3 shows a front view of a roof module on a vehicle roof, and

FIG. 4 shows a top view of a roof module according to the invention.

The illustration of FIG. 1 shows a highly schematic omnibus 1 as a vehicle. This omnibus 1 comprises a roof module 3 on its vehicle roof 2 which is disposed in the rear section in the direction of travel F. This roof module is covered in the illustration of FIG. 1 by a covering hood 4, with the color and shape of the covering hood 4 typically being adapted to the design of the omnibus 1. The covering hood 4 also comprises ventilation slots 5 in the embodiment of the roof module 3 as illustrated here, reference to which will be made below in closer detail. The omnibus 1 shall be equipped with a hybrid drive in the embodiment of the omnibus 1 as shown here, especially a diesel/electric hybrid. As is frequently the case in omnibuses 1, a drive engine 6 in form of a diesel engine is arranged in the rear section of the omnibus 1 in the direction of travel F. It drives two wheels 9 via a transmission unit 7 and a driven axle 8 of the omnibus 1 and thus the omnibus 1. Furthermore, the omnibus 1 comprises an electric drive motor 10 which acts via the transmission unit 7 on the driven axle 8 of the omnibus 1 together with the diesel engine 6. The electric drive motor 10 is connected to an electric storage unit 12 via an electronic unit 11 which especially comprises a converter and power-electronic components. The generally known drive of the omnibus 1 via the hybrid drive occurs in such a way that the diesel engine 6 provides at least a part of the power required for driving the omnibus 1. In situations where more power is needed such as when driving away or accelerating, electric power can be supplied via the electric drive motor 10. When omnibus 1 is braked, the electric drive motor 10 can be operated in a regenerative manner. The electronic unit 11 can be used to draw a predetermined current from the electric motor 10, thus producing a predetermined drag torque in the electric motor 10 which brakes the omnibus 1. The electric power thus reclaimed during braking of the omnibus 1 is then stored in the electric storage unit 12.

Very high currents can occur during the recovery of braking energy, the so-called recuperation, especially when using such a hybrid drive in comparatively heavy commercial vehicles and omnibuses. In order to enable storing them in the electric storage unit 12 it is necessary to choose a storage unit which has comparatively low internal resistance and thus stores the major part of the current instead of converting the same into heat. The electric storage unit 12 is therefore made up of electric storage modules 13 which are shown in the following drawings and which are composed of high-performance capacitors, the so-called supercaps. The electric storage unit 12 will be arranged with the electronic unit 11, which is the converter and the power electronics, in the roof module 3 which will be described below in closer detail and which is illustrated in FIG. 2 by a dot-dash line. In addition to these components, the omnibus 1 can further comprise an air-conditioning system 14 which is only indicated here in principle and which is driven indirectly for example by the diesel engine 6 and provides cooled air, especially for the interior space of the omnibus 1.

As already indicated in the description of FIG. 1, the roof module 3 can be covered by a random covering hood 4 which is typically predetermined by the manufacturer of the omnibus and which is indicated in principle in the illustration of FIG. 1. The functional arrangement of the roof module 3 as shown in FIG. 1 is disposed under said covering hood 4, which roof module 3 comprises the electric storage unit 12 in form of electric storage modules 13 and the electronic unit 11 (covered here) in form of a converter 11.1 and power electronics 11.2. The structure of the roof module 3 is arranged on a support frame 15 which is shown in a front view in FIG. 3. Two longitudinal struts 16 can be seen in this view which extend in the direction of travel F and are attached to the vehicle roof 2. Moreover, the support frame 15 comprises at least one, preferably several, transverse struts 17, of which one can be recognized here. This transverse strut 17 is arranged on the longitudinal struts 16 in such a way that a bulging of the vehicle roof 1 beneath the roof module 3 can occur without leading to any contact with the roof module 3.

Five electric storage modules 13 can be recognized on the transverse strut or struts 17 in the case illustrated here. These electric storage modules 13 are respectively made up of several high-performance capacitors or supercaps. They are fixed to the support frame 15 and can thus be mounted as an electric storage unit 12 on the vehicle roof 2 together with the electronic unit 11 and the support frame 15. In the area of the support frame 15, and in this case especially on the two longitudinal struts 16, a shielding plate 18 is arranged. Said shielding plate 18 is arranged as zinc-plated sheet metal part and covers the entire base area of the support frame 15 without having any supporting properties itself. It is connected, as is common practice for shielding plates 18, with the ground lines or the ground terminal of the electronic components, i.e. the electric energy storage modules 13 and the converter 11.1 and the power electronics 11.2. This arrangement is shown in closer detail in the top view of the roof module in FIG. 4. Furthermore, two fans 19 are provided at the front on the electric energy storage modules in the direction of travel F. They can be switched on if necessary in order to cool the electric energy storage modules 13. Otherwise, cooling occurs at least partly by the incoming airstream that penetrates the region of the roof module 3, e.g. via the ventilation slots 5 which have already been described in connection with FIG. 1.

The roof module 3 is produced as a self-supporting pre-mounted unit. Respective receiving elements or receiving points 20 can be provided, especially in the region of the longitudinal struts 16, as shown in the illustration of FIG. 4. Irrespective of the configuration and size of the components in the roof module 3, these receiving points 20 can be adjusted at constant width of the support frame 15 in such a way that they will fit accordingly onto different vehicle roofs 2 of different vehicles 1, e.g. different series of omnibuses of a manufacturer, and will find bearing elements there for fastening the same. The readily pre-mounted roof module 3 which is then applied to the vehicle roof 2 can finally be covered with the covering hood which is merely shown in FIG. 1. This is not decisive for functionality but is primarily relevant concerning the visual appearance and the air resistance.

As is shown in a top view of FIG. 4, the roof module 3 comprises numerous electric line elements, of which only a few are shown by way of example with reference numeral 21. The electric line elements are guided between the converter 11.1 and the power electronics 11.2 and also between the power electronics 11.2 and the individual electric energy storage modules 13 in such a way that the feed line and the return line are disposed closely with respect to one another. This partly occurs in the region of the electric energy storage modules 13 in such a way that the lines 21 extend along electronic boxes 22 at one end of the electric energy storage modules 13, with the respective return line then being arranged in the interior of the electronic module 22 towards the preceding line extending on the outside on the module. In combination with the zinc-plated shielding plate 18 which is connected with the grounding lines in the region of a grounding connection 23 and which is arranged beneath the components of the roof module 3 in the region of the support frame 15, this configuration with electric feed and return lines being disposed very closely with respect to one another ensures that the components of the roof module 3 are shielded electromagnetically very well against the vehicle 1 and the electronic systems disposed therein, and in the case of an omnibus the persons too who are situated therein. This configuration allows favorable cooling of the electronic components in combination with good shielding and high flexibility of the roof module 3, e.g. for different vehicles.

1-12. (canceled)

13. A roof module for mounting on a roof of a vehicle, comprising:
a self-supporting support frame on which components are mounted;
the support frame is arranged independently of the vehicle roof;
the components comprise at least one electric energy storage module,
characterized in that
a shielding plate is arranged on the support frame between the electric energy storage modules and the vehicle roof.

14. The roof module according to claim 13, characterized in that the shielding plate is arranged on the side of a part of the support frame connected with the vehicle roof, which side faces way from the vehicle roof.

15. The roof module according to claim 13, characterized in that the support frame comprises two longitudinal struts and at least one transverse strut.

16. The roof module according to claim 14, characterized in that the support frame comprises two longitudinal struts and at least one transverse strut.

17. The roof module according to claim 13, characterized in that the electric energy storage modules are made up of high-performance capacitors.

18. The roof module according to claim 14, characterized in that the electric energy storage modules are made up of high-performance capacitors.

19. The roof module according to claim 15, characterized in that the electric energy storage modules are made up of high-performance capacitors.

20. The roof module according to claim 16, characterized in that the electric energy storage modules are made up of high-performance capacitors.

21. The roof module according to claim 13, characterized in that the electric energy storage modules are arranged at the front in the direction of travel.

22. The roof module according to claim 14, characterized in that the electric energy storage modules are arranged at the front in the direction of travel.

23. The roof module according to claim 15, characterized in that the electric energy storage modules are arranged at the front in the direction of travel.

24. The roof module according to claim 16, characterized in that the electric energy storage modules are arranged at the front in the direction of travel.

25. The roof module according to claim 17, characterized in that the electric energy storage modules are arranged at the front in the direction of travel.

26. The roof module according to claim 13, characterized in that the components further comprise at least one converter and power electronics.

27. The roof module according to claim 13, characterized in that it comprises an electric storage unit for a hybrid drive of the vehicle.

28. The roof module according to claim 13, characterized in that the electric line elements leading to and from the components are each arranged close to one another.

29. The roof module according to claim 13, characterized in that the electric energy storage modules comprise fans.

30. The roof module according to claim 13, characterized in that cooled air can be supplied via an air-conditioning system to the region before the electric energy storage modules in the direction of travel of the vehicle.

31. The roof module according to claim 13, characterized in that it can be sealed with a covering hood.

32. The roof module according to claim 13, characterized in that the vehicle is arranged as a commercial vehicle, especially an omnibus.
